(19) United States
(12) Patent Application Publication
(10) Pub. No.: US 2013/0277229 A1
(43) Pub. Date: Oct. 24, 2013

(54) NOVEL METAL COMPLEX CATALYSTS AND USES THEREOF

(71) Applicant: University of Memphis Research Foundation, (US)

(72) Inventors: Xuan Zhao, Memphis, TN (US); Charles Edwin Webster, Memphis, TN (US)

(73) Assignee: University of Memphis Research Foundation, Memphis, TN (US)

(21) Appl. No.: 13/867,992

(22) Filed: Apr. 22, 2013

Related U.S. Application Data
(60) Provisional application No. 61/636,704, filed on Apr. 22, 2012.

(51) Int. Cl. B01J 31/22; C25B 1/02; C01B 3/02; C01B 3/06

(52) U.S. Cl. CPC B01J 31/2295; C01B 3/06; C25B 1/02; C01B 3/02
USPC 205/637; 423/657; 546/12; 204/157.52

(57) ABSTRACT

The invention relates to novel metal complexes useful as catalysts in redox reactions (such as, hydrogen (H₂) production). In particular, the invention provides novel transition metal (e.g., cobalt (Co) or nickel (Ni)) complexes, in which the transition metal is coupled with N,N-Bis(2-pyridinylmethyl)-2,2′-Bipyridine-6-methanamine (DPA-Bpy), 6′-((bis(pyridin-2-ylmethyl)amino)methyl)-N,N-dimethyl-2,2′-bipyridin-6-amine (DPA-ABpy), or a derivative thereof. The invention also relates to a method of producing H₂ from an aqueous solution by using the metal complex as a catalyst. In certain embodiments, the invention provides a metal complex of the formulae as described herein.

### CROSS-REFERENCE TO RELATED APPLICATIONS

This application claims the benefit of the following U.S. Provisional Application No. 61/636,704, filed Apr. 22, 2012, the entire content of which is incorporated herein by reference.

### STATEMENT OF RIGHTS TO INVENTIONS MADE UNDER FEDERALLY SPONSORED RESEARCH

This work was supported by the National Science Foundation (NSF), Grant No. EPS 1004083; and the National Cancer Institute under Grant No. P30A027165. The government has certain rights in the invention.

### BACKGROUND

The use of H₂ as a potential source of clean and renewable fuel has attracted great interest in an effort to reduce current dependence on fossil fuels.^{[1]} Reduction of water to H₂, especially with visible light, has been a subject of intense study and a significant amount of efforts have been devoted towards designing metal complexes for proton reduction.

Over the past few years, a number of H₂ evolution catalysts based on metal complexes such as Co^{[2]} Ni,^{[3]} Fe,^{[4]} and Mo^{[5]} have been reported and studied, especially in nonaqueous media, to provide insights into the mechanism of proton reduction. Recently, Eisenberg and coworkers described photocatalytic proton reduction catalyzed by a mononuclear cobalt-dithiolene complex with remarkable turnover number (TON) of >2700 per mol of Co catalyst in a 1:1 ratio of CH₃CN/H₂O.^{[2h]}

Although there has been significant progress in designing molecular catalysts for H₂ evolution, the search of robust and highly active catalysts that can operate in purely aqueous solution, by either electrochemical or photochemical approaches, still remains a great challenge.^{[2e, 6]}

### SUMMARY OF THE INVENTION

The invention provides novel metal complexes that are useful as catalysts in redox reactions. In particular, the invention provides metal complexes, which comprise at least one transition metal complexed with N,N-bis(2-pyridinylmethyl)-2,2′-bipyridine-6-methanamine (DPA-Bpy) or its derivative thereof. The metal complexes of the invention are useful as catalysts in hydrogen production. In certain embodiments, the invention provides novel Co complexes as efficient electrocatalysts for producing H₂ from an aqueous solution. In other embodiments, the invention provides novel Co complexes as efficient photocatalysts for producing H₂ from an aqueous solution

In one aspect, the invention relates to a metal complex of formula (I)

[M(G)Y]ₘ(X)ₙ(L)ₐ (I)

wherein

M is a transition metal;

G is N,N-bis(2-pyridinylmethyl)-2,2′-bipyridine-6-methanamine (DPA-Bpy) or a derivative thereof;

Y, on each occurrence, independently is a halogen group or a water moiety;

X, on each occurrence, independently is an anion;

m is the number of cations per metal complex;

n is the number of anions per metal complex;

L is absent or a neutral molecule; and

a is the number of neutral molecules per metal complex;

provided that when G is N,N-bis(2-pyridinylmethyl)-2,2′-bipyridine-6-methanamine (DPA-Bpy), M is not Ru.

In certain embodiments, M is Co, Ru, or Fe. In one embodiment, M is Co.

In a separate embodiment, Y in the formula (I) is chloride.

In one embodiment, a is 0. In another embodiment, a is 1.

In certain embodiments, the invention provides a metal complex of formula (I), in which X is the same on each occurrence and is Cl⁻.

In other embodiments, L in the formula (I) is (C₁₋₃)alkyl-CN (e.g., CH₃CN).

In specific embodiments, the invention provides cobalt complexes, such as, Co(DPA-Bpy)Cl₂ (“complex 1”) and [Co(DPA-Bpy)(Cl)]Cl₂.(CH₃CN).

In certain embodiments, the invention provides a metal complex of formula (II)

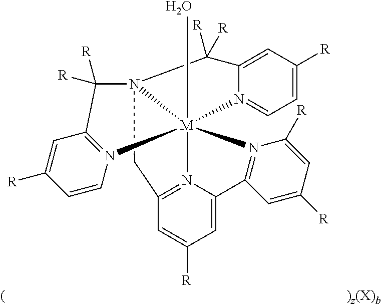

wherein

M is Co, Ru, Ni, or Fe;

R, on each occurrence, independently is H, (C₁₋₃)alkyl, cyano, aryl, benzyl, amino, nitrile, carboxylate, hydroxyl, or ester;

X, on each occurrence, independently is an anion

z is the number of cations per metal complex, and

b is the number of anions per metal complex;

or a salt, solvate or hydrate thereof.

In one embodiment, M in the formula (II) is Co. In another embodiment, M in the formula (II) is Ni.

In one embodiment, z in the formula (II) is 1.

In another embodiment, X is the same on each occurrence and is PF6⁻. In a separate embodiment, X is the same on each occurrence and is BF₄⁻.

In certain embodiments, the invention provides [Co(DPA-Bpy)(OH₂)](PF₆)₃ (“complex 2”). The invention also provides Ni(DPA-ABpy)(OH₂)](BF₄) (“complex 3”).

In another aspect, the invention provides a metal complex of formula (III):

[M(G)Y]ₘ(X)ₙ(L)ₐ (III)

or a salt, solvate or hydrate thereof;
wherein

M is a transition metal;

G is N,N-bis(2-pyridinylmethyl)-2,2′-bipyridine-6-methanamine (“DPA-Bpy”), 6′-((bis(pyridin-2-ylmethyl)amino)methyl)-N,N-dimethyl-2,2′-bipyridin-6-amine (“DPA-ABpy”), or a derivative thereof;

Y, on each occurrence, independently is absent, a halogen group or a water moiety;

X, on each occurrence, independently is an anion;

m is the number of cations per metal complex;

n is the number of anions per metal complex;

L is absent or a neutral molecule; and

a is the number of neutral molecules per metal complex;

provided that when G is N,N-bis(2-pyridinylmethyl)-2,2′-bipyridine-6-methanamine (“DPA-Bpy”), M is not Ru.

In one instance, the invention provides [Ni(DPA-ABpy)(OH₂)](BF₄)₂. In another instance, the invention provides [Ni(DPA-Bpy)(OH₂)](BF₄)₂.

In still another instance, the invention provides a metal complex of [Co(DPA-ABpy)](PF₆)₂.

The invention also provides the metal complexes in the form of salts, solvates, hydrates, or stereoisomers.

In another aspect, the invention relates to a catalyst, which comprises a metal complex of the invention.

The invention also provides a process for producing hydrogen from an aqueous solution by using a catalyst of the invention. The process comprises a step of adding the catalyst to the aqueous solution. In one instance, an electrolysis step is performed after the addition of the catalyst to the aqueous solution. In a certain situation, the aqueous solution after the addition of the catalyst has a pH value at about 7.

In another instance, the process of the invention includes a photolysis step on the aqueous solution after the catalyst is added. In one example, the aqueous solution also contains ascorbic acid. In another example, the pH value of the aqueous solution is within the range of about 3 to 6. In a specific example, the pH value of the aqueous solution is about 4.

In a particular embodiment, the invention relates to using [Co(DPA-Bpy)(OH₂)](PF₆)₃, [Ni(DPA-Bpy)(OH₂)](BF₄)₂, [Ni(DPA-ABpy)(OH₂)](BF₄)₂, or [Co(DPA-ABpy)](PF₆)₂, as the catalyst for the hydrogen production.

The invention further provides design and synthesis of the metal complexes of the invention.

In certain embodiments, the invention relates to a method of preparing a metal complex of the invention, which is characterized by

1) adding a metal salt or its hydrate thereof to a solution containing N,N-Bis(2-pyridinylmethyl)-2,2′-Bipyridine-6-methanamine, or 6′-((bis(pyridin-2-ylmethyl)amino)methyl)-N,N-dimethyl-2,2′-bipyridin-6-amine (“DPA-ABpy”), or a derivative thereof in a reaction solvent to obtain a mixture; and

2) refluxing the mixture of step 1).

### BRIEF DESCRIPTION OF THE FIGURES

FIG. 1 presents molecular structure of [Co(DPA-Bpy)(Cl)]Cl₂.(CH₃CN) with thermal ellipsoids drawn at the 50% probability level.

FIG. 2 is UV-visible spectra of complex 1 (dashed line) and complex 2 (solid line) in H₂O.

FIGS. 3a-b. (3a) UV-vis spectra change of complex 2 at varying pH; (3b) Absorbance change vs pH at 470 nm and 478 nm for complex 2. The best-fit lines from both 470 nm (solid line) and 478 nm (dashed line) yield a pKₐ of 5.0.

FIG. 4 is EPR spectra in water: (a) complex 1 and (b) complex 2. Samples were recorded in 2 mM aqueous solution containing 10% glycerol at 15 K and 15 dB microwave power; microwave frequency, 9.050 GHz.

FIGS. 5a-c are cyclic voltammograms of (a) complex 1, (b) complex 1 and (c) DPA-Bpy ligand in the presence of ferrocene in CH₃CN solution, 0.1 M TBAP. Scan rate, 100 mV/s; working electrode, glassy carbon; reference electrode, Ag/AgCl; counter electrode, Pt wire. Ferrocene (*) was included as an internal reference (0.64 V vs SHE).

FIG. 6 is a pourbaix diagram for the Co^{III/II} redox couple of complex 2 in aqueous Britton-Robinson buffer (E_{1/2} vs SHE).

FIG. 7 are cyclic voltammograms of 1.0 M sodium phosphate buffer solution at pH 7.0 in the presence (solid line) and absence (dotted line) of 50 μM complex 2. Scan rate, 100 mV/s; working electrode, mercury pool; counter electrode, Pt mesh; reference electrode, aqueous Ag/AgCl.

FIGS. 8a-b are charts showing charge build-up over (a) time (200 s) and (b) overpotential for the controlled potential electrolysis of 50 μM complex 2 in 1.0 M sodium phosphate buffer at pH 7.0.

FIGS. 9a-b. present results of controlled potential electrolysis at −1.4 V (vs SHE). (a) In the presence (solid line) and absence (dotted line) of 50 μM complex 2; (b) Stability test of 50 μM complex 2 in 1.0 M sodium phosphate buffer solution at pH 7.0. working electrode, mercury pool; counter electrode, Pt mesh; reference electrode, aqueous Ag/AgCl.

FIGS. 10a-b are GC-TCD chromatograms of H₂ production over time: (a) In 1.0 M acetate buffer at pH 4.0 containing complex 2 (5.0 μM), [Ru(bpy)₃]²⁺ (0.5 mM), and ascorbic acid (0.1 M). LED light, 450 nm. (b) Control experiments in the absence of ascorbic acid, light, [Ru(bpy)₃]²⁺, or Complex 2.

FIG. 11 is a chart showing photocatalytic H₂ evolution at various pH values. Conditions: 10 mL 1.0 M buffer solutions with [ascorbic acid]=0.1 M, [Ru(bpy)₃]²⁺ =0.5 mM, [complex 2]32 5.0 μM, LED light: 450 nm.

FIG. 12 is a chart showing photocatalytic H₂ evolution at various concentration of complex 2. Conditions: 10 mL 1.0 M acetate buffer at pH 4.0, [ascorbic acid]=0.1 M, [Ru(bpy)₃]²⁺=0.5 mM, LED light: 450 nm.

FIG. 13 is a chart showing photocatalytic H₂ production over time. Conditions: 10 mL 1.0 M acetate buffer at pH 4.0, [ascorbic acid]=0.5 M, [Ru(bpy)₃]²⁺=2.0 mM, [complex 2]=5.0 μM, LED light: 450 nm.

FIG. 14 is a chart showing photocatalytic H₂ production over time. Conditions: 10 mL 1.0 M acetate buffer at pH 4.0, [ascorbic acid]=0.1 M, [Ru(bpy)₃]²⁺=0.5 mM, [2]=5.0 μμM, LED light: 450 nm. The arrow indicates addition of complex 2 (5.0 μM) and [Ru(bpy)₃]²⁺ (0.5 mM) after H₂ evolution stopped at indicated time.

FIG. 15 presents relative free energy diagrams of postulated catalytic cycles of H₂ evolution by complex 2. Relative free energies are given per mole of H₂ produced.

FIG. 16 is a chart presenting cyclic Voltammogram of complex 2 in 1.0 M sodium phosphate buffer at pH 7.0. Scan rate, 100 mV/s. Working electrode, glassy carbon; reference electrode, Ag/AgCl; counter electrode, Pt wire.

FIG. 17 is chart presenting potocatalytic H₂ production over time in 1.0 M acetate buffer at pH 4.0 with 0.1 M ascorbic acid, 0.5 mM [Ru(bpy)₃]²⁺, and 5.0 μM Complex 2 at 22° C.

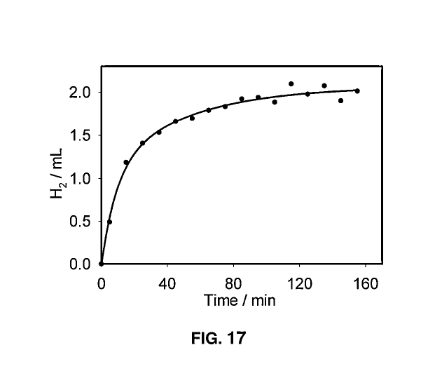

FIGS. 18a-b) present molecular structures of (a) [Ni(DPA-ABpy)(H₂O)][BF₄]₂ (complex 3) and (b) [Co(DPA-ABpy)][PF₆]₂ (complex 4).

### DETAILED DESCRIPTION

The invention provides novel metal complexes useful as catalysts in redox reactions. In particular, the invention provides novel transition metal (e.g., cobalt or nickel) complexes supported by a pentadentate ligand (such as, DPA-Bpy or DPA-ABpy), which can serve as catalysts for efficient H₂ production/evolution from aqueous solutions.

### DEFINITIONS

The term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The term alkyl further includes alkyl groups, which can further include oxygen, nitrogen, sulfur or phosphorous atoms replacing one or more carbons of the hydrocarbon backbone, e.g., oxygen, nitrogen, sulfur or phosphorous atoms.

As used herein, the term “aryl” refers to the radical of aryl groups, including 5- and 6-membered single-ring aromatic groups that may include from zero to four heteroatoms, for example, benzene, pyrrole, furan, thiophene, imidazole, benzoxazole, benzothiazole, triazole, tetrazole, pyrazole, pyridine, pyrazine, pyridazine and pyrimidine, and the like. Aryl groups also include polycyclic fused aromatic groups such as naphthyl, quinolyl, indolyl, and the like. Those aryl groups having heteroatoms in the ring structure may also be referred to as “aryl heterocycles,” “heteroaryls” or “heteroaromatics.” The aromatic ring can be substituted at one or more ring positions with such substituents as described above, as for example, halogen, hydroxyl, alkoxy, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, sulfonato, sulfamoyl, sulfonamido, nitro, trifluoromethyl, cyano, azido, heterocyclyl, alkylaryl, or an aromatic or heteroaromatic moiety. Aryl groups can also be fused or bridged with alicyclic or heterocyclic rings which are not aromatic so as to form a polycycle (e.g., tetralin).

The term “carboxylate” refers to a moiety derived from a carboxylic group, for example, an alkyl-C(O)O— group.

The term “chiral” refers to molecules which have the property of non-superimposability of the mirror image partner, while the term “achiral” refers to molecules which are superimposable on their minor image partner.

In this disclosure, “comprises,” “comprising,” “containing” and “having” and the like can have the meaning ascribed to them in U.S. Patent law and can mean “ includes,” “including,” and the like; “consisting essentially of” or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

The term “diastereomers” refers to stereoisomers with two or more centers of dissymmetry and whose molecules are not minor images of one another.

The term “halogen” designates —F, —Cl, —Br or —I.

The term “hydrate” refers to a metal complex of the invention or a salt thereof, which further includes a stoichiometric or non-stoichiometric amount of water bound by non-covalent intermolecular forces.

The term “hydroxyl” means —OH.

The term “heteroatom” as used herein means an atom of any element other than carbon or hydrogen. Heteroatoms include, such as, nitrogen, oxygen, sulfur and phosphorus.

The term “isotopic forms” refer to variants of a particular chemical element. All isotopes of a given element share the same number of protons, and each isotope differs from the others in its number of neutrons.

As used herein, “redox reactions” refer to reduction-oxidation reactions, in which certain atoms in chemical reagents involved in the reaction have their oxidation state changed.

As used herein, “a transition metal” refers to the element as appear in Groups 3 through 12 of the Periodic Table of the Elements, or an isotopic form thereof. The transition metals include, for example, iron (Fe), cobalt (Co), nickel (Ni), ruthenium (Ru), rhodium (Rh), manganese (Mn), technetium (Tc), palladium (Pd) and etc.

The term “solvate” as used herein refers to solvate forms of the metal complexes of the present invention.

### Metal Complexes

The invention provides metal complexes that are useful as catalysts in redox reactions. In particular, the invention provides metal complexes as efficient catalysts for hydrogen production. In certain embodiments, the metal complexes of the invention are efficient electrocatalysts for producing H₂ from an aqueous solution. In other embodiments, the metal complexes of the invention are efficient photocatalysts for producing H₂ from an aqueous solution.

The metal complexes of the invention, for example, comprise at least one transition metal complexed with DPA-Bpy or its derivative thereof. In particular, the invention provides novel cobalt (Co) complexes, which comprise Co complexed with N,N-Bis(2-pyridinylmethyl)-2,2′-Bipyridine-6-methanamine (DPA-Bpy) or a derivative thereof. In certain embodiments, said derivative of DPA-Bpy is DPA-Bpy contains one or more substituents.

In certain embodiments, the invention provides a metal complex of formula (I)

[M(G)Y]ₘ(X)ₙ(L)ₐ (I)

wherein

M is a transition metal;

G is N,N-bis(2-pyridinylmethyl)-2,2′-bipyridine-6-methanamine (DPA-Bpy) or a derivative thereof;

Y, on each occurrence, independently is a halogen group or a water moiety (i.e., H₂O);

X, on each occurrence, independently is an anion;

m is the number of cations per metal complex;

n is the number of anions per metal complex;

L is absent or a neutral molecule; and

a is the number of neutral molecules per metal complex;

provided that when G is N,N-bis(2-pyridinylmethyl)-2,2′-bipyridine-6-methanamine (DPA-Bpy), M is not Ru.

In certain embodiments, the transition metal of the formula (I) is Co, Ni, Ru, or Fe.

Suitable anions for use as X include, such as, a fluorine ion, a chlorine ion (i.e., Cl⁻), a bromine ion, an iodine ion, a sulfide ion, an oxide ion, a hydroxide ion, a hydride ion, a sulfite ion, a phosphate ion, a cyanide ion, an acetate ion, a carbonate ion, a sulfate ion, a nitrate ion, a hydrogen carbonate ion, a trifluoroacetate ion, an 2-ethylhexanoate ion, a thiocyanide ion, a trifluoromethane sulfonate ion, an acetyl acetonate, a tetrafuloroborate ion, a hexafluorophosphate ion (i.e., PF6⁻), a tetrafluoro borate ion (i.e., BF₄⁻), and a tetraphenyl borate ion.

In certain embodiments, X is selected from the group of a chloride ion, a hexafluorophosphate ion, a tetrafluoro borate ion, a bromide ion, an iodide ion, an oxide ion, a hydroxide ion, a hydride ion, a phosphate ion, a cyanide ion, an acetate ion, a carbonate ion, a sulfate ion, a nitrate ion, a 2-ethylhexanoate ion, an acetyl acetonate, and a tetraphenyl borate ion.

In certain embodiments of the metal complexes of the formula (I), X is the same on each occurrence and is Cl⁻. In other embodiments, X is the same on each occurrence and is PF₆⁻.

Y, on each occurrence, independently is a halogen group (such as, F, Cl, Br, I) or a water moiety. In one embodiment, Y is Cl. In another embodiment, Y is H₂O.

L in the formula (I) is either absent or a neutral molecule. Examples of the neutral molecule include, for example, alkyl-cyanide (such as, acetonitrile), water, methanol, ethanol, n-propanol, isopropyl alcohol, 2-methoxyethanol, 1,1-dimethyl ethanol, ethylene glycol, N,N′-dimethyl formamide, N,N′-dimethyl acetamide, N-methyl-2-pyrrolidone, dimethyl sulfoxide, acetone, chloroform, acetonitrile, benzonitrile, triethyl amine, pyridine, pyrazine, diazabicyclo[2,2,2]octane, 4,4′-bipyridine, tetrahydrofuran, diethyl ether, dimethoxy ethane, methylethyl ether, and 1,4-dioxane, and preferably water, methanol, ethanol, isopropyl alcohol, ethylene glycol, N,N′-dimethyl formamide, N,N′-dimethyl acetamide, N-methyl-2-pyrrolidone, chloroform, acetonitrile, benzonitrile, triethyl amine, pyridine, pyrazine, diazabicyclo[2,2,2]octane, 4,4′-bipyridine, tetrahydrofuran, dimethoxy ethane, and 1,4-dioxane.

In one embodiment, L in the formula (I) is (C₁₋₃)alkyl-cyanide(e.g., acetonitrile; “CH₃CN”).

In one embodiment, a in the formula (I) is 0. In another embodiment, a is 1.

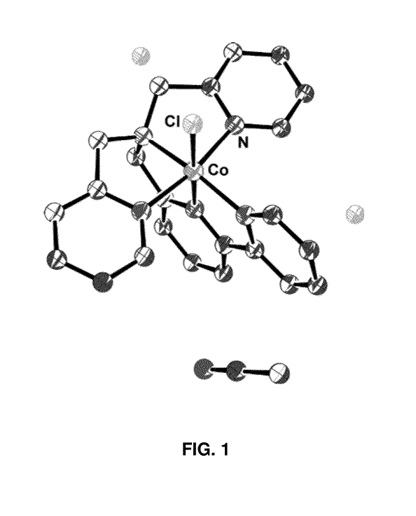

In specific embodiments, the invention provides cobalt complexes, such as, Co(DPA-Bpy)Cl₂ (or “Complex 1”) and [Co(DPA-Bpy)(Cl)]Cl₂.(CH₃CN) (see FIG. 1 for its molecular structure).

The structure of Co(DPA-Bpy)Cl₂ is provided as follows:

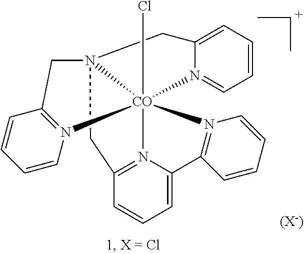

In certain embodiments, the invention provides a metal complex of formula (II)

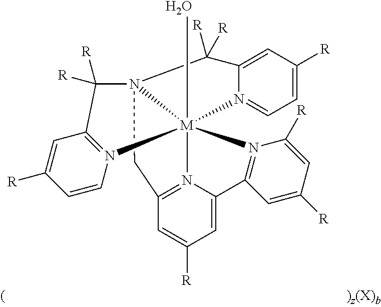

wherein

M is Co, Ru, Ni, or Fe;

R, on each occurrence, independently is H, (C₁₋₃)alkyl, cyano, aryl, benzyl, amino, nitrile, carboxylate, hydroxyl, or ester;

X, on each occurrence, independently is an anion;

z is the number of cations per metal complex; and

b is the number of anions per metal complex;

or a salt, solvate or hydrate thereof.

In certain embodiments, M in the formula (II) is Co. In other embodiments, M in the formula (II) is Ni.

In one embodiment, z in the formula (II) is 1. In another embodiment, X is the same on each occurrence and is PF₆⁻. In still another embodiment, X is the same on each occurrence and is BF₄⁻.

For example, the invention provides [Co(DPA-Bpy)(OH₂)](PF₆)₃ (“complex 2”) with the following structure:

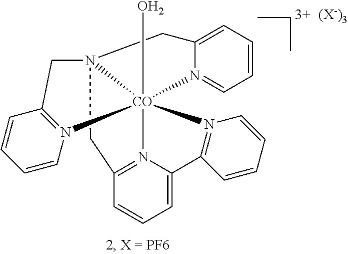

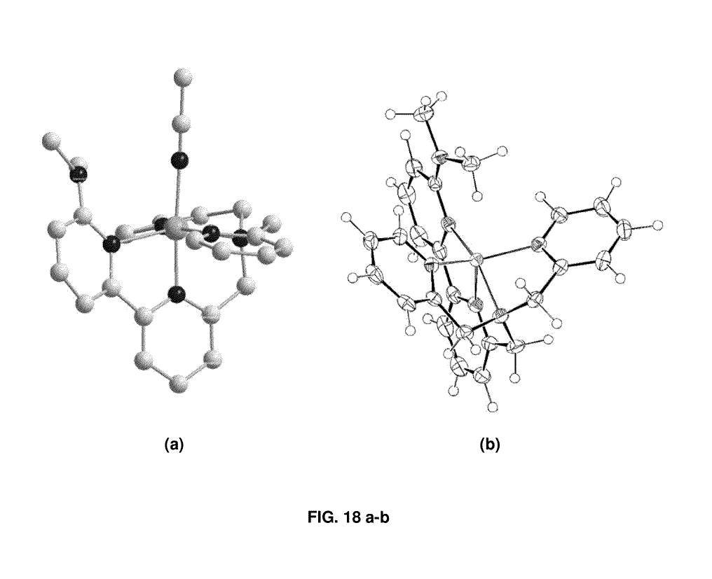

The invention also provides [Ni(DPA-ABpy)(OH₂)](BF₄) (“complex 3”) with the structure presented in FIG. 18a. As shown in FIG. 18a, the Ni center in complex 3 is in an octahedral geometry, with the 6th ligand being a solvent molecule.

Alternatively, the invention provides [Ni(DPA-Bpy)(H₂O)] (BF₄)₂ as a metal complex.

The invention also provides a metal complex of formula (III):

[M(G)Y]ₘ(X)ₙ(L)ₐ (III)

or a salt, solvate or hydrate thereof;
wherein

M is a transition metal;

G is N,N-bis(2-pyridinylmethyl)-2,2′-bipyridine-6-methanamine (DPA-Bpy), 6′-((bis(pyridin-2-ylmethyl)amino)methyl)-N,N-dimethyl-2,2′-bipyridin-6-amine (DPA-ABpy), or a derivative thereof;

Y, on each occurrence, independently is absent, a halogen group or a water moiety;

X, on each occurrence, independently is an anion;

m is the number of cations per metal complex;

n is the number of anions per metal complex;

L is absent or a neutral molecule; and

a is the number of neutral molecules per metal complex;

provided that when G is N,N-bis(2-pyridinylmethyl)-2,2′-bipyridine-6-methanamine (“DPA-Bpy”), M is not Ru.

In formula (III), the transition metal (“M”) can be, for example, Co, Ru, Ni, or Fe. In one embodiment, G is DPA-Bpy. In another embodiment, G is DPA-ABpy.

In certain embodiments, Y is absent. In other embodiments, Y is a water moiety.

X can be any ion as above delineated. In one embodiment, X is PF₆⁻. In another embodiment, X is BF₄⁻. Further, X can be the same or different on each occurrence in a metal complex.

Exemplified metal complexes of formula (III) include, for example, [Ni(DPA-ABpy)(OH₂)](BF₄)₂ (“complex 3”) and [Co(DPA-ABpy)](PF₆)₂ (“complex 4”), or a salt, solvate or hydrate thereof. As illustration, the structure of complex 4 is provided in FIG. 18b. As can be seen from FIG. 18b, the Co center in complex 4 adopts a triganol bipyramidal geometry.

The invention also provides the metal complexes in the form of salts, solvates, hydrates, or stereoisomers of the metal complexes as described herein.

The metal complex of the invention may form a layered crystal lattice. In certain embodiments, the metal complexes of the invention further include metal complexes in which a metal-containing compound, for example a salt or another metal complex, is incorporated into the crystal lattice of the metal complex of the invention. In this case, in the formulae (I) to (III), a portion of the cobalt can be replaced by other metal ions, or further metal ions can enter into a more or less pronounced interaction with the metal complex.

The structures of the metal complexes of the invention may include asymmetric carbon atoms. Accordingly, the isomers arising from such asymmetry (e.g., racemates, racemic mixtures, single enantiomers, individual diastereomers, diastereomeric mixtures) are included within the scope of this invention, unless indicated otherwise.

The metal complexes of the invention can be obtained by: synthesizing the ligand organo-chemically; and mixing the ligand and a reaction agent that provides the metal atom in a reaction solvent.

Isomers of the metal complexes of the invention can be obtained in substantially pure form by classical separation techniques and/or by stereochemically controlled synthesis. For example, optical isomers may be prepared from their respective optically active precursors by the procedures described above, or by resolving the racemic mixtures. The resolution can be carried out in the presence of a resolving agent, by chromatography or by repeated crystallization or by some combination of these techniques which are known to those skilled in the art. Further details regarding resolutions can be found in Jacques, et al., Enantiomers, Racemates, and Resolutions (John Wiley & Sons, 1981). The metal complexes of this invention may also be represented in multiple tautomeric forms, in such instances, the invention expressly includes all tautomeric forms of the metal complexes described herein (e.g., alkylation of a ring system may result in alkylation at multiple sites, the invention expressly includes all such reaction products).

In addition, the metal complexes of the invention may contain one or more double or triple bonds in their structures. Thus, the metal complexes can occur as cis- or trans- or E- or Z-double isomeric forms, which are included within the scope of this invention.

Further, all crystal forms of the metal complexes of the invention are also expressly included in the present invention.

A metal complex of the invention can be prepared as an acid by reacting the free base form of the compound with a suitable inorganic or organic acid. Alternatively, a metal complex of the invention can be prepared as a base by reacting the free basic form of the compound with a suitable inorganic or organic base. For example, a metal complex of the invention in an acid addition salt form can be converted to the corresponding free base by treating with a suitable base (e.g., ammonium hydroxide solution, sodium hydroxide, and the like). A metal complex of the invention in a base addition salt form can be converted to the corresponding free acid by treating with a suitable acid (e.g., hydrochloric acid, etc.).

Alternatively, the salt forms of the metal complexes of the invention can be prepared using salts of the starting materials or intermediates.

Protected derivatives of the metal complexes of the invention can be made by means known to those of ordinary skill in the art. A detailed description of techniques applicable to the creation of protecting groups and their removal can be found in T. W. Greene, “Protecting Groups in Organic Chemistry”, 3rd edition, John Wiley and Sons, Inc., 1999.

The metal complexes of the present invention can be conveniently prepared, or formed during the process of the invention, as solvates (e.g., hydrates). Hydrates of the metal complexes of the invention can be conveniently prepared by recrystallization from an aqueous/organic solvent mixture, using organic solvents such as dioxin, tetrahydrofuran or methanol.

The metal complexes of this invention may be modified by attaching to various other ligands via any means delineated herein to enhance catalytic properties.

The metal complexes of the invention are defined herein by their chemical structures and/or chemical names. Where a metal complex is referred to by both a chemical structure and a chemical name, and the chemical structure and chemical name conflict, the chemical structure is determinative of the compound's identity.

The recitation of a listing of chemical groups in any definition of a variable herein includes definitions of that variable as any single group or combination of listed groups. The recitation of an embodiment for a variable herein includes that embodiment as any single embodiment or in combination with any other embodiments or portions thereof.

### Processes And Methods

The invention also provides a catalyst, which comprises a metal complex of the invention.

Further, the invention provides a process for producing hydrogen by using a catalyst of the invention. In certain embodiments, hydrogen is produced from an aqueous solution. The process comprises a step of adding the catalyst to a solution (such as, an aqueous solution).

In one instance, an electrolysis step is performed after the addition of the catalyst to the aqueous solution. In a certain situation, the aqueous solution after the addition of the catalyst has a pH value at about 7.

In another instance, the process of the invention includes a photolysis step on the aqueous solution after the catalyst is added. In one example, the aqueous solution also contains ascorbic acid. In another example, the pH value of the aqueous solution is within the range of about 3 to 6. In a specific example, the pH value of the aqueous solution is about 4.

In one embodiment, the invention relates to using a cobalt metal complex (such as, [Co(DPA-Bpy)(OH₂)](PF₆)₃ and [Co(DPA-ABpy)](PF₆)₂) as the catalyst for hydrogen production.

The invention also provides a nickel metal complex (e.g., [Ni(DPA-ABpy)(OH₂)](BF₄) or [Ni(DPA-Bpy)(H₂O)](BF₄)₂) as the catalyst.

The metal complex of the invention can be obtained by mixing a ligand and a metal-providing agent in the presence of an appropriate reaction solvent.

For example, a metal complex of the invention can be prepared by the following method:

1) adding a metal salt or its hydrate thereof to a solution containing a pentadentate ligand (such as, N,N-Bis(2-pyridinylmethyl)-2,2′-Bipyridine-6-methanamine or 6′-((bis(pyridin-2-ylmethyl)amino)methyl)-N,N-dimethyl-2,2′-bipyridin-6-amine) or a derivative thereof in a reaction solvent to obtain a mixture; and

2) refluxing the mixture of step 1).

Examples of suitable reaction solvent include water, acetonitrile, acetic acid, oxalic acid, ammonia water, methanol, ethanol, n-propanol, isopropyl alcohol, 2-methoxyethanol, 1-butanol, 1,1-dimethylethanol, ethylene glycol, diethyl ether, 1,2-dimethoxyethane, methylethyl ether, 1,4-dioxane, tetrahydrofuran, benzene, toluene, xylene, mesitylene, durene, decalin, dichloromethane, chloroform, carbon tetrachloride, chlorobenzene, 1,2-dichlorobenzene, N,N′-dimethylformamide, N,N′-dimethyl acetamide, N-methyl-2-pyrrolidone, dimethylsulfoxide, acetone, benzonitrile, triethylamine, and pyridine. A reaction solvent obtained by mixing two or more kinds of them may be used and a solvent which can dissolve a ligand and a metal-providing agent is preferred.

In certain embodiments, the reaction solvent is water, acetonitrile, or a mixture thereof.

Reactions can be performed at a temperature of about −10 to 200° C., for example, 0 to 150° C., or 0 to 100° C. The reaction can be performed in a time period of about 1 minute to 1 week, such as, 5 minutes to 24 hours, or about 1 hour to 12 hours. The reaction temperature and the reaction time can also be appropriately optimized depending on the kinds of the ligand, the metal-providing agent, and chemical reagents used in the reaction.

Reactions for preparing the metal complexes of the invention may use acids and/or bases to facilitate its progress. Acids and bases useful in the methods herein are known in the art. Acids include any acidic chemicals, which can be inorganic (e.g., ascorbic acid, hydrochloric, sulfuric, nitric acids, aluminum trichloride) or organic (e.g., camphorsulfonic acid, p-toluenesulfonic acid, acetic acid, ytterbium triflate) in nature. Acids are useful in either catalytic or stoichiometric amounts to facilitate the reactions. Bases refer to any basic chemicals, which can be inorganic (e.g., sodium bicarbonate, potassium hydroxide) or organic (e.g., triethylamine, pyridine) in nature. Bases are useful in either catalytic or stoichiometric amounts to facilitate the reactions.

Additionally, various preparation steps may be performed in an alternate sequence or order to give the desired metal complexes. In addition, the solvents, temperatures, reaction durations, etc. delineated herein are for purposes of illustration only and one of ordinary skill in the art will recognize that variation of the reaction conditions can produce the desired metal complexes of the present invention. Synthetic chemistry transformations and protecting group methodologies (protection and deprotection) useful in synthesizing the metal complexes described herein are known in the art and include, for example, those such as described in R. Larock, Comprehensive Organic Transformations, VCH Publishers (1989); T. W. Greene and P. G. M. Wuts, Protective Groups in Organic Synthesis, 2d. Ed., John Wiley and Sons (1991); L. Fieser and M. Fieser, Fieser and Fieser's Reagents for Organic Synthesis, John Wiley and Sons (1994); and L. Paquette, ed., Encyclopedia of Reagents for Organic Synthesis, John Wiley and Sons (1995), and subsequent editions thereof.

The prepared metal complexes can be separated from the reaction mixture and further purified by a method described herein and/or by methods, such as, a recrystallization method, a redeposit method, and a chromatography method. Further, two or more of the separation methods may be employed in combination. As can be appreciated by the skilled artisan, further methods of synthesizing and/or separating the metal complexes of the formulae herein will be evident to those of ordinary skill in the art.

The produced metal complex may precipitate depending on the kind of the reaction solvent; the precipitated metal complex can be isolated and purified by separating the metal complex by a solid-liquid separation method such as filtration and subjecting the separated product to a washing operation and a drying operation as required.

The invention further provides design and synthesis of metal complexes that are useful as catalysts in redox reactions.

### Density Functional Theory (DFT) Calculations

Theoretical calculations were carried out with the Gaussian 09 software package (M. J. Frisch et al., Gaussian, Inc., Wallingford, Conn., 2009). Density functional theory was used with PBE exchange and correlation functionals in conjunctions with default pruned course grids for gradients and Hessians (35, 110) [neither grid is pruned for cobalt], and the default SCF convergence criterion for geometry optimizations (10⁻⁸) (R. G. Parr et al., Density Functional Theory of Atoms and Molecules, Oxford University Press, New York, 1989; J. P. Perdew et al., Phys. Rev. Lett. 1996, 77, 3865-3868; and J. P. Perdew et al., Phys. Rev. Lett. 1997, 78, 1396). Two basis set combinations were utilized in this study. For BS1, the basis set utilized for cobalt was the Hay and Wadt basis set (BS) and effective core potential (ECP) combination (LanL2DZ) as modified by Couty and Hall, where the two outermost p functions have been replaced by a (41) split of the optimized cobalt 4p function; and the 6-31G(d′) basis sets were used for all other atoms (P. J. Hay et al., J. Chem. Phys. 1985, 82, 299-310; M. Couty et al., J. Comput. Chem. 1996, 17, 1359-1370; W. J. Hehre et al., J. Chem. Phys. 1972, 56, 2257; & P. C. Hariharan et al. Theor. Chim. Acta 1973, 28, 213-222).

For BS2, the all electron 6-311+G** basis sets were used for all atoms (R. Krishnan et al., J. Chem. Phys. 1980, 72, 650-654; K. Raghavachari et al., J. Chem. Phys. 1989, 91, 1062-1065; P. J. Hay, J. Chem. Phys. 1977, 66, 4377-4384; A. J. H. Wachters, J. Chem. Phys. 1970, 52, 1033-1036). The density fitting approximation for the fitting of the Coulomb potential was used for all PBE calculations; auxiliary density-fitting basis functions were generated automatically for the specified AO basis set (B. I. Dunlap, J. Chem. Phys. 1983, 78, 3140-3142; B. I. Dunlap, J Mol Struc-Theochem 2000, 529, 37-40; B. I. Dunlap et al., J. Chem. Phys. 1979, 71, 3396-3402; B. I. Dunlap et al., J. Chem. Phys. 1979, 71, 4993-4999). The Hessian was computed on gas-phase optimized geometries and standard statistical mechanical relationships were used to determine the change in Gibbs Free energy in the gas phase, ΔG_{gas}. The solvation free energies, ΔGₛₒₗᵥ, were calculated using the SMD method (A. V. Marenich et al., J. Phys. Chem. B 2009, 113, 6378-6396). The SMD solvation model was used with the default parameters consistent with water and acetonitrile as the solvent.

The reaction free energy changes of possible mechanisms in water were calculated with the free energy changes in the gas phase and the solvation free energies of the reactants and products in a Born-Haber cycle (Eq. 1). The computed free energy of solution, ΔG^{comp}_{so ln}, is calculated from the free energy change in the gas phase of the redox couple, gas ΔG^{redox}_{gas}, the solvation free energy change between the oxidized [ΔG^{comp}ₛₒₗᵥ(ox)] and the reduced species [ΔG^{comp}ₛₒₗᵥ(red)], and the number of protons, lost from the complex to solution (n) (Eq 1). In order to account for the loss of a proton to solvent water or acetonitrile, the experimental value for the solvation of a proton [ΔG^{exp}_{H}_{₂}_{O}(H⁺)=−265.9 kcal/mol and ΔG^{exp}_{acetonitrile}(H⁺)=−260.2 kcal/mol] and the gas-phase Gibbs free energy of a proton [ΔG^{exp}_{gas}(H⁺)=−6.28 kcal mol⁻¹] were used (C. P. Kelly et al., J. Phys. Chem. B 2006, 111, 408-422; C. P. Kelly et al., J. Phys. Chem. B 2006, 110, 16066-16081; and A. Moser et al., J. Phys. Chem. B 2010, 114, 13911-13921).

ΔG^{comp}_{so ln}=ΔG^{redox,comp}_{gas}+G^{comp}ₛₒₗᵥ(red)−ΔG^{comp}ₛₒₗᵥ(ox)=n[ΔG^{exp}ₛₒₗᵥ(H⁺)+ΔG^{exp}_{gas}(H⁺)] Eq 1

ΔG^{comp}_{so ln} in acetonitrile are used to determine the standard one electron redox potential, E^{°,comp}_{so ln},
where F is the Faraday constant, 23.06 kcal mol⁻¹ V⁻¹ (Eq 2).

$${E}_{so ln}^{° , comp} = - \frac{{ΔG}_{so ln}^{comp}}{1 \times F} \qquad Eq 2$$

### Calculations on Metal Complexes of the Invention and Possible Mechanisms

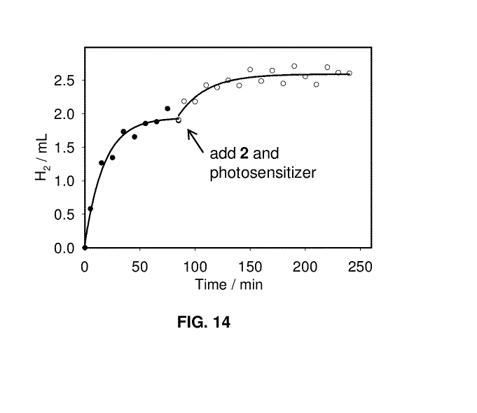

To provide insight into the mechanism of proton reduction by complex 2, DFT calculations were performed to explore the possible reaction intermediates, and the reaction free energy changes of possible pathways for proton reduction (see Table 1, Schemes A and B and FIG. 14).

The computed reduction potentials of complex 2 in water are shown in Table 1.

| | Exp. | BS1 | BS2 |
|---|---|---|---|
| Co^{III/II} | 0.15 | 0.09 | 0.08 |
| Co^{II/I} | −0.90 | −1.07 | −0.71 |

Table 1. Experimental and computed redox potentials of complex 2 in water, E_{1/2}, V vs SHE

Without wishing to be bound by any theory, Scheme A presents possible mechanisms of H₂ evolution/production catalyzed by the cobalt complexes of the invention.

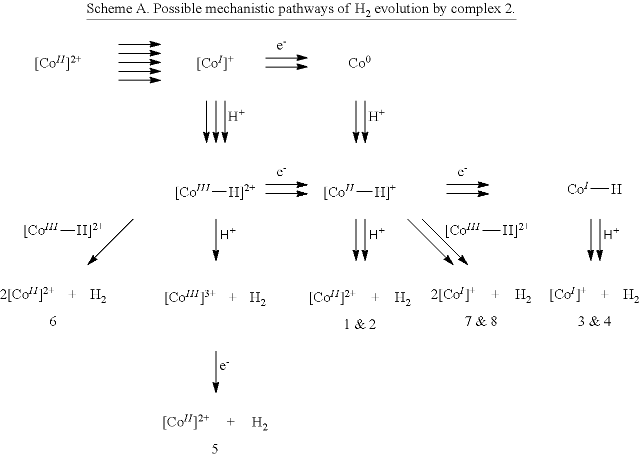

In the above scheme, pathways 1-5 show mononuclear reactions and pathways 6-8 show dinuclear reactions of the H₂ evolution.

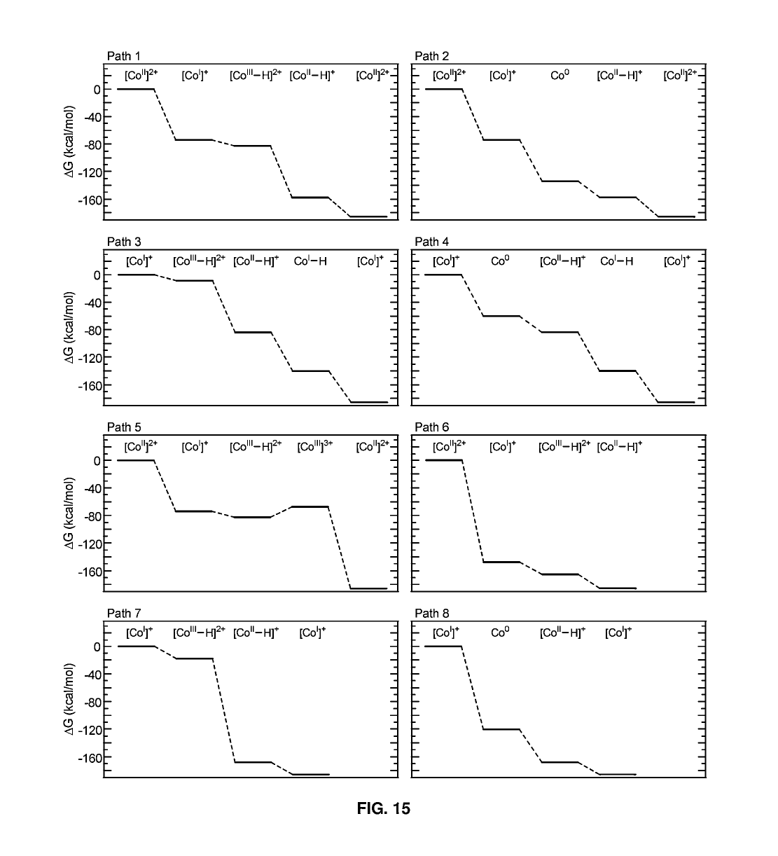

FIG. 15 demonstrates the relative energy change of each step for the pathways listed in Scheme A. Dinuclear mechanisms are plotted with 2 moles of reaction species. Except pathway 5, all the mechanistic pathways are thermodynamically favored. Therefore, further kinetic and mechanistic studies are needed to differentiate the reaction pathways listed in Scheme A.

Free energy changes of the mechanistic steps were calculated and provided in Scheme B:

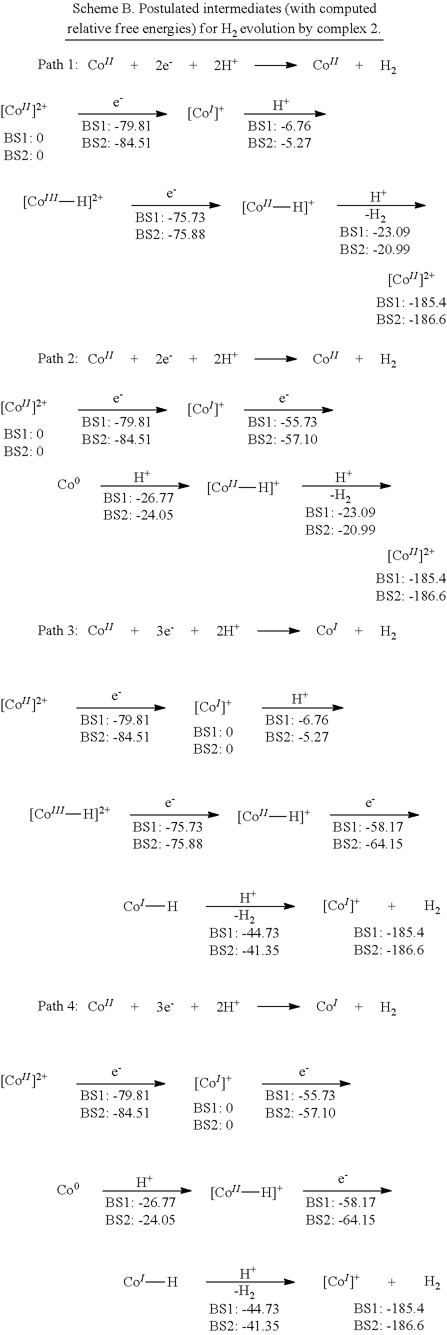

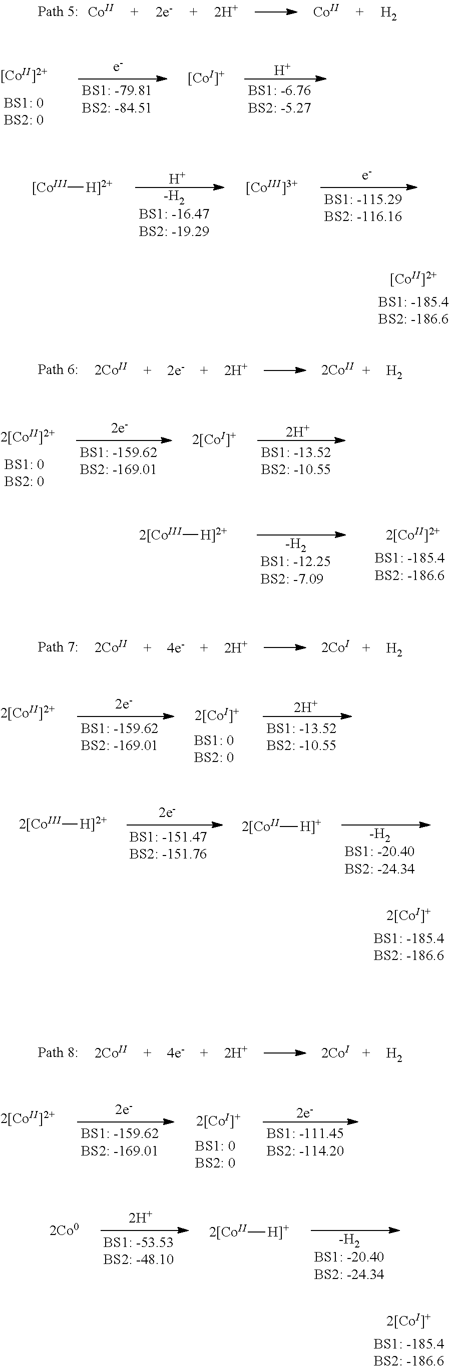

In Scheme B, units in mononuclear reactions (Path 1-5) are kcal mole of cobalt; and units in dinuclear reactions (Path 5-8) are kcal/2 moles of cobalt. Values below reaction arrows are free energy changes of each step (Δ(ΔG)); values given in bold font are relative free energies of catalytic species for the production of H₂ (ΔG).

The free energy change of H₂ evolution, 2H⁺+2e⁻→H₂, was found to be −185.4 kcal/mol (BS1) and −186.6 kcal/mol (BS2), which are 4.02 V (BS1) and 4.05 V (BS2) for calculated absolute potentials. These computed values are 0.4 V lower than the experimental value for the absolute potential of the SHE in water (4.44±0.02 V) (S. Trasatti, Pure Appl. Chem. 1986, 58, 955-966). The differences in the values for the redox potentials are relatively accurate.

Results from DFT computations suggest that a number of reaction pathways are thermodynamically favorable for proton reduction by complex 2, such as the one shown in Scheme 2 where the binding of proton to the Co^{I} form of complex 2 yields the Co^{III}—H species. Further reduction of Co^{III}—H to Co^{II}—H species followed by binding of another proton results in H₂ evolution (Scheme 2).

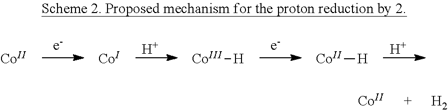

Results from DFT computations suggest that a number of reaction pathways are thermodynamically favourable for proton reduction by complex 2, such as the one shown in Scheme 2 where the binding of proton to the Co^{I} form of complex 2 yields the Co^{III}−H species. Further reduction of Co^{III}—H to Co^{II}—H species followed by binding of another proton results in H₂ evolution (Scheme 2).

### EXEMPLIFICATION OF THE INVENTION

The following examples are put forth so as to provide those of ordinary skill in the art with a complete disclosure and description of how to make and use the metal complexes of the invention. The method for preparation can include the use of one or more intermediates, chemical reagents and synthetic routes as delineated herein.

### I. GENERAL PROCEDURES AND INSTRUMENTATION

The metal complexes of the invention can be prepared or used by methods described in this section, the examples, and the chemical literature.

### 1. Materials and Syntheses

All experiments were conducted under an Ar atmosphere unless noted. All chemicals and reagents were purchased from Sigma-Aldrich unless noted. Ascorbic acid, Hg of electronic (99.9998%) or puratronic (or 99.999995%) grade were purchased from Alfa Aesar. Water (18.2 MΩ) was purified using Milli-Q system. N,N-Bis(2-pyridinylmethyl)-2,2′-bipyridine-6-methanamine (DPA-Bpy) was synthesized according to literature method (B. Radaram et al., Inorg. Chem. 2011, 50, 10564-10571).

### 2. Instrumentation

UV-vis absorption spectra were measured using a HP-8452A diode array spectrometer. ESI-MS spectra were obtained from ThermoElectron LCQ Advantage liquid chromatograph mass spectrometer. The formation of H₂ was determined by an HP 5890 series II Gas Chromatograph with a TCD detector (Molecular sieve 5 Å column). Photocatalytic reactions were carried out using an LED (Cree 3-Up XP-E) lamp at 450 nm. Elemental analyses were done by Atlantic Microlab, Inc, Atlanta, Georgia. EPR spectra were recorded on a Varian-122 X-band spectrometer equipped with an Air Products Helitran cryostat and temperature controller at the Illinois Electron Paramagnetic Resonance Research Center of the University of Illinois.

Cyclic voltammetric measurements were performed with a CH Instruments potentiostat (Model 660) in 0.1 M TBAP in acetonitrile or 1.0 M pH 7.0 sodium phosphate buffer using glassy carbon working electrode, platinum wire counter electrode, and Ag/AgCl reference electrode. Controlled potential electrolysis was conducted in 1.0 M sodium phosphate buffer at pH 7 in an H-type gas-tight dual compartment cell. A mercury pool with a surface area of 4.9 cm² was used as working electrode, connected through a platinum wire placed at the bottom of the mercury pool. An aqueous Ag/AgCl reference electrode (BASi) was placed in electrolyte solution above mercury pool. A platinum gauze, used as auxiliary electrode, was placed in the other compartment partition from the solution of the working electrode. Both working and auxiliary compartments contained 22.5 mL electrolyte solutions, which were thoroughly degassed by purging with Ar for 30 min prior to each experiment. Faradaic efficiency was determined with 50 μM complex 2 at an applied potential of −1.3 and −1.4 V vs SHE. The volume of H₂ produced during electrolysis was determined by GC-TCD or measured by a gas buret. The experiments were performed at 22° C. and the vapor pressure of water at 22° C. (19.8 mmHg) was corrected in calculating the current efficiency of H₂ production.

### 3. General Procedure for Photocatalytic Hydrogen Production

For photoinduced hydrogen evolution, each sample was prepared in a 130 mL rectangular flask containing 10 mL of 1.0 M pH 4.0 acetate buffer in the presence of [Ru(bpy)₃]Cl₂ (0.5 mM), ascorbic acid (0.1 M), and complex 2 (5.0 μM). The solution was sealed with a septum, degassed under vacuum and flushed with Ar gas (with 5% CH₄ as internal standard) four times before irradiation. The samples were irradiated by a LED light (450 nm) at room temperature with constant stirring. The amounts of hydrogen evolved were determined by gas chromatography using a HP 5890 series II Gas Chromatograph with a TCD detector or measured by a gas burette placed in a circulated water bath maintained at 22° C.

### II. PREPARATION AND EXPERIMENTS

### EXAMPLE 1

### Synthesis and Characterization of Complex 1 and Complex 2

The reaction of CoCl₂.6H₂O with DPA-Bpy in refluxing CH₃CN results in a reddish cloudy solution. After filtration, the filtrate was dried under vacuum and washed with Et₂O to yield Co(DPA-Bpy)Cl₂ (complex 1) as a light-pink powder (Scheme 1).

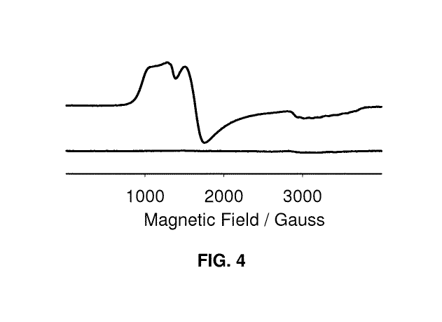

Refluxing an aqueous solution of Complex 1 in the presence of AgPF₆ led to the formation of an aqua complex [Co(DPA-Bpy)(OH₂)](PF₆)₃ (complex 2).The oxidation of complex 1 by AgPF₆ led to the formation of complex 2, which showed an EPR-silent Co^{III} center (FIG. 4b).

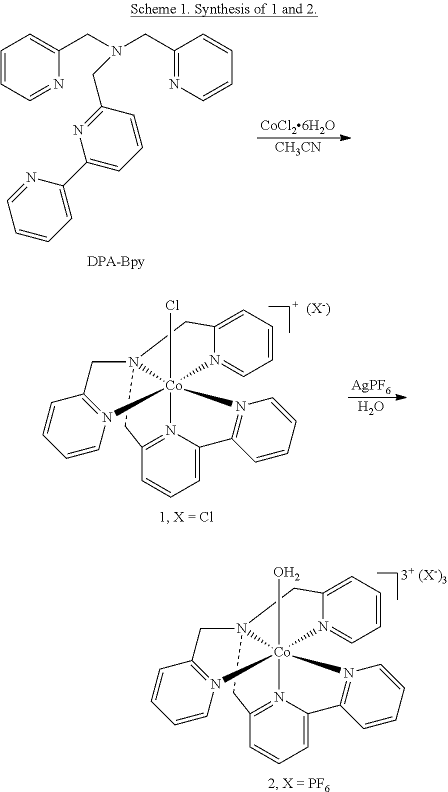

### a) Synthesis of [Co(DPA-Bpy)Cl]Cl (Complex 1) and Analysis

To a refluxed solution of CoCl₂.6H₂O (0.207 g, 1 mmol) in 10 mL CH₃CN was added dropwise a solution of 1-(2,2′-bipyridin-6-methyl) N,N′-Bis(2-pyridyl methyl) amine (DPA-Bpy, 0.367 g, 1 mmol) in 5 mL CH₃CN for a period of 15 mins. The resulting cloudy solution was refluxed for 6 hrs and then filtered through a glass frit membrane. The filtrate was evaporated under reduced pressure, dissolved in minimum amount of CH₃CN, and washed with diethyl ether to yield the product as a light pink powder. Yield, 0.17 g (33%). Anal. Calcd for C₂₃H₂₁Cl₂CoN₅.(H₂O)_{1.5}: C, 52.69; H, 4.61; N, 13.36. Found: C, 52.52; H, 4.55; N, 13.33. ESI-MS: m/z⁺ 461.1 (Calcd m/z⁺ for [Co(DPA-Bpy)Cl]⁺ 461.8).

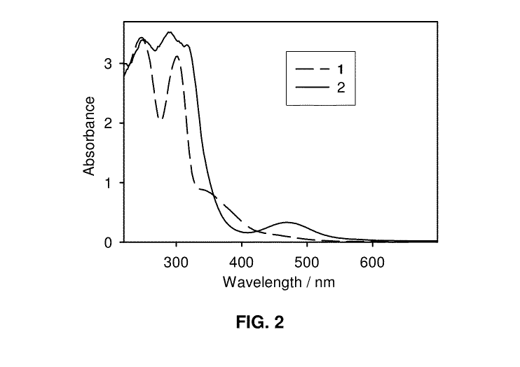

The crystal structure of the Co^{III} form of complex 1 (FIG. 1) confirmed that DPA-Bpy serves as a pentadentate ligand with the Co center in a distorted octahedral geometry with two trans pyridines groups, similar to that of Ru(DPA-Bpy)Cl₃.^{[8]} The UV-vis spectrum of Complex 1 in water shows two intense bands at 247 and 300 nm from ligand π→π* transitions, a shoulder peak at 337 nm, and a weak shoulder at 420 nm from metal d-d transition (FIG. 2). The EPR spectrum of complex 1 exhibited rhombic splitting pattern with g values of 5.56, 3.95, and 1.98, suggesting the presence of a high-spin Co^{II} center (FIG. 4a).^{[9]}

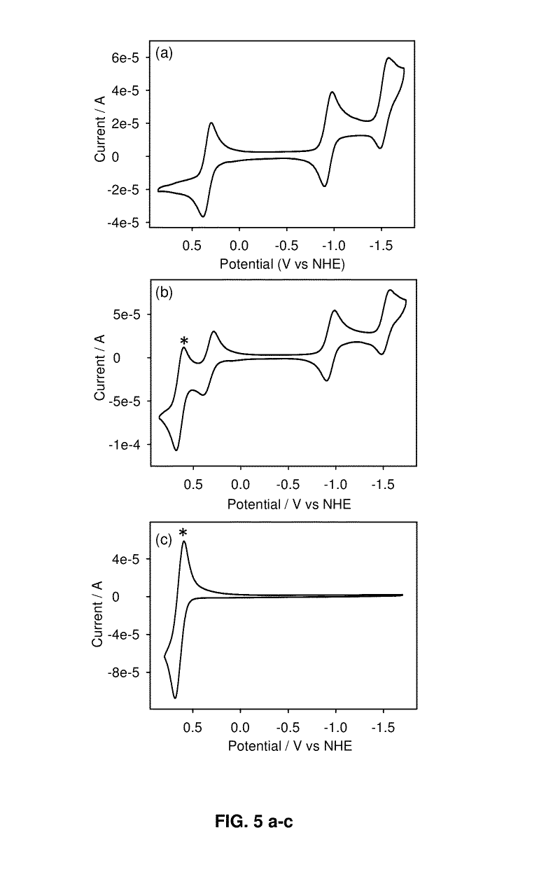

The cyclic voltammogram of complex 1 in CH₃CN displays three reversible redox potentials at 0.35, −0.94, and −1.53 V (vs SHE), assignable to Co^{III/II}, Co^{II/I}, and Co^{I/O}, respectively (FIGS. 5a and 5b). In the same region, ligand DPA-Bpy does not show any redox behaviour (FIG. 5c).

### b) Synthesis of [Co(DPA-Bpy)(OH₂)](PF₆)₃ (Complex 2) and Analysis

To a solution of [Co(DPA-Bpy)Cl]Cl (0.2665 g, 0.54 mmol) in 15 mL H₂O was added dropwise a solution of AgPF₆ (0.4554 g, 1.8 mmol) in 10 mL of H₂O under Ar atmosphere. The reaction mixture was refluxed for 12 hrs. After the precipitate was filtered through celite, water was removed under reduced pressure and the residue was dissolved in minimum amount of methanol, washed with diethyl ether, and dried under vacuum to get the yellow solid [Co(DPA-Bpy)(OH₂)](PF₆)₃ (Complex 2) Yield: 0.39 g (88%). ESI-MS: m/z⁺ 587.9 (Calcd m/z⁺ for [Co(DPA-Bpy)(OH)(PF₆)]⁺, 588.4). Anal. Calcd for C₂₃H₂₃CoF₁₈N₅OP₃.H₂O: C, 30.82; H, 2.70; N, 7.81. Found: C, 30.73; H, 2.81; N, 7.80.

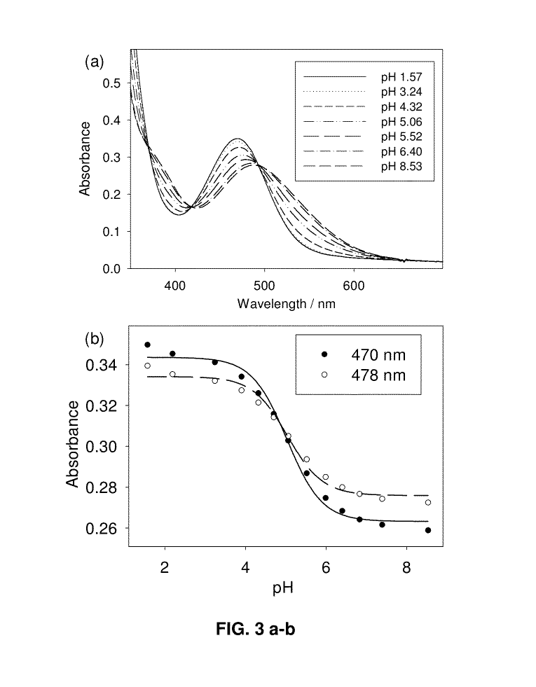

Compared to complex 1, complex 2 displays an absorption band at 470 nm from metal d-d transition (FIG. 2). The pKₐ of the coordinated H₂O in complex 2 was determined to be 5.0 by fitting the pH titration curve of complex 2 from pH 1 to 9 (FIG. 3).

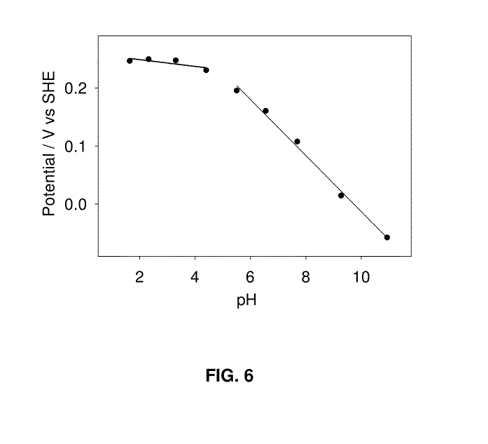

In 1.0 M sodium phosphate buffer at pH 7.0, complex 2 exhibits a sequence of two redox events centered at 0.15 and −0.90 V (vs SHE), corresponding to Co^{III/II} and Co^{II/I}, respectively (FIG. 15). The Co^{III/II} couple displays a pH-dependent redox potential change, with a slope of −48 mV/pH in the range of pH 5-8 (FIG. 6), suggesting a proton-coupled electron transfer process. However, the Co^{III/II} couple only changes slightly over pH 1-5. The Pourbaix diagram of complex 2 is consistent with a pKa of 4.8 for the Co^{III}—OH₂ species, similar to that obtained from pH titration of complex 2.

### EXAMPLE 2

### Synthesis of DPA-ABpy and Metal Complexes 3 and 4

To provide a possible H-bonding network to M-H species during H₂ production, an NMe₂-group was introduced into the DPA-Bpy scaffold (DPA-ABpy), which was synthesized based on the following Scheme 2.

### Scheme 2, Synthesis DPA-ABpy.

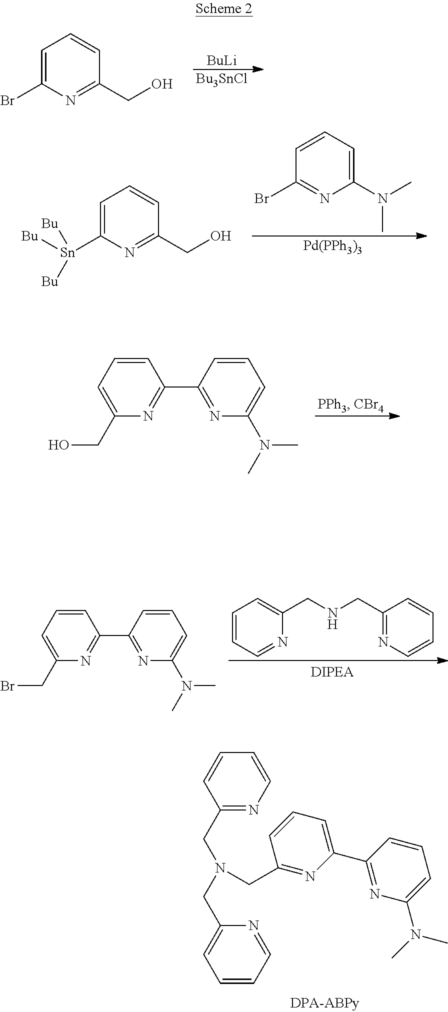

The reaction of DPA-ABpy with Ni(CH₃CN)₆(BF₄)₂ and Co(CH₃CN)₆(PF₆)₂ in a mixed solution of acetone/H₂O (1:9) results in the formation of [Ni(DPA-ABpy)(H₂O)][BF₄]₂ (complex 3) and [Co(DPA-ABpy)][PF₆]₂ (complex 4), respectively.

X-ray structural analysis of complexes complex 3 and complex 4 confirmed the coordination of DPA-ABpy to metal centers as a pentadentate ligand. While the Ni center in complex 3 is in an octahedral geometry, with the 6th ligand being a solvent molecular, the Co center in complex 4 adopts a triganol bipyramidal geometry (see FIG. 18a and FIG. 18b).

### EXAMPLE 3

### Electrolysis

To evaluate the current efficiency of H₂ production, bulk electrolysis of 1.0 M phosphate buffer at pH 7 was carried out in the presence of complex 2 under room temperature at a potential of −1.4 V (vs SHE). The amounts of H₂ produced during electrolysis or photocatalysis were determined by gas chromatography using a HP 5890 series II Gas Chromatograph with a TCD detector (Molecular sieve 5 Å column) or measured volumetrically by a gas burette.

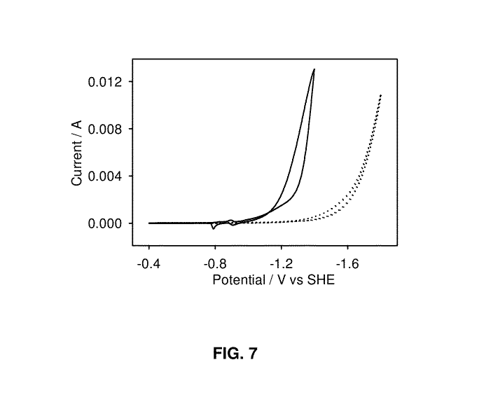

When mercury pool was used as the working electrode, the cyclic voltammogram of 1.0 M sodium phosphate buffer at pH 7 showed no significant current at potentials more positive than −1.6 V vs SHE (FIG. 7). However, in the presence of complex 2, a strong current appeared at −1.20 V vs SHE concomitant with gas bubbles formation, which was confirmed to be H₂ by GC-TCD analysis (GC=gas chromatography, TCD=thermal conductivity detector). The study suggested that complex 2 is capable of catalyzing proton reduction to H₂ from neutral water.

### EXAMPLE 4

### Control Potential Experiments

To determine the overpotential for proton reduction by complex 2, control potential experiments using an H-type electrochemical cell were performed. Controlled potential electrolysis was conducted in 1.0 M sodium phosphate buffer at pH 7 in an H-type gas-tight dual compartment cell. A mercury pool with a surface area of 4.9 cm² was used as working electrode that was connected through a platinum wire placed at the bottom of the mercury pool. The solution was stirred constantly during controlled potential electrolysis experiments.

A platinum gauze wire, used as auxiliary electrode, was placed in the other compartment partition from the solution of the working electrode. Aqueous Ag/AgCl electrode was used as the reference electrode. The working and auxiliary compartments both contained 22.5 mL of electrolyte solution, which were thoroughly degassed by purging with Ar for 30 min prior to the experiments. Faradaic efficiency was determined with 50 μM complex 2 at an applied potential of −1.3 and −1.4 V vs SHE. The experiments were performed at 22° C. and the vapor pressure of water at 22° C. (19.8 mmHg) was corrected in calculating the current efficiency of H₂ production.

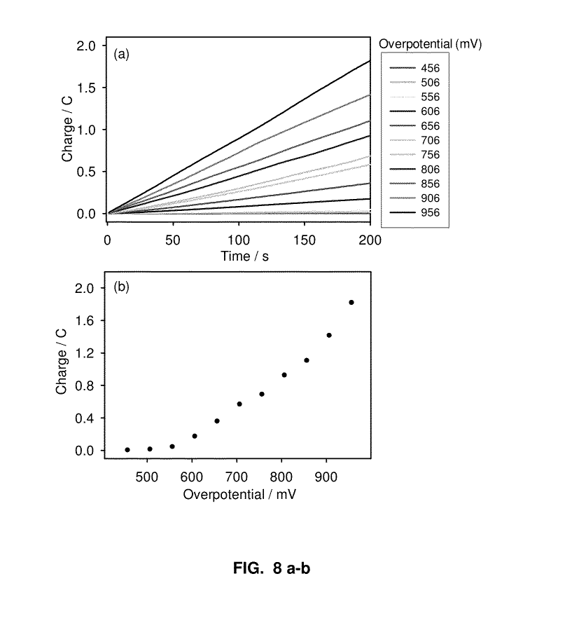

FIG. 8 displays the charge build-up over 200-sec electrolysis at varied potentials for 50 μM complex 2 in 1.0 M phosphate buffer at pH 7. There is no significant charge consumption for overpotentials below −0.55 V, and the catalytic current for proton reduction occurs at an overpotential of −0.60 V (−1.01 V vs SHE), close to the Co^{II/I} couple at −0.90 V (vs SHE).

For complex 2 in the range of 50 μM-1 mM, a current efficiency of 99±1% (Table 2) was obtained for H₂ evolution at pH 7 (Table 2).

TABLE 2
Experimental results from controlled-potential electrolysis
on 2 in 1.0M phosphate buffer at pH 7

| Sample Number | 1 | 2 | 3 | 4 | 5 | 6 | 7 | 8 | 9 |
|---|---|---|---|---|---|---|---|---|---|
| Applied Potential, | −1.40 | −1.40 | −1.40 | −1.40 | −1.40 | −1.30 | −1.30 | −1.30 | −1.30 |
| (V vs SHE) | | | | | | | | | |
| Coulombs (C) | 22.2 | 22.1 | 28.0 | 28.2 | 63.6 | 20.3 | 24.0 | 31.1 | 42.4 |
| Calcd Volume of H₂ | 2.78 | 2.76 | 3.49 | 3.52 | 7.93 | 2.53 | 3.03 | 3.87 | 5.28 |
| (mL) | | | | | | | | | |
| Obs'd Volume | 2.8 | 2.8 | 3.5 | 3.6 | 8.2 | 2.6 | 3.0 | 3.9 | 5.3 |
| Change (mL) | | | | | | | | | |
| Expt H₂ Volume | 2.7 | 2.7 | 3.4 | 3.5 | 8.0 | 2.5 | 2.9 | 3.8 | 5.2 |
| (mL) | | | | | | | | | |
| Current Efficiency | 98.6 | 98.9 | 97.6 | 99.6 | 100.7 | 100.1 | 96.4 | 98.1 | 97.8 |
| (%) | | | | | | | | | |

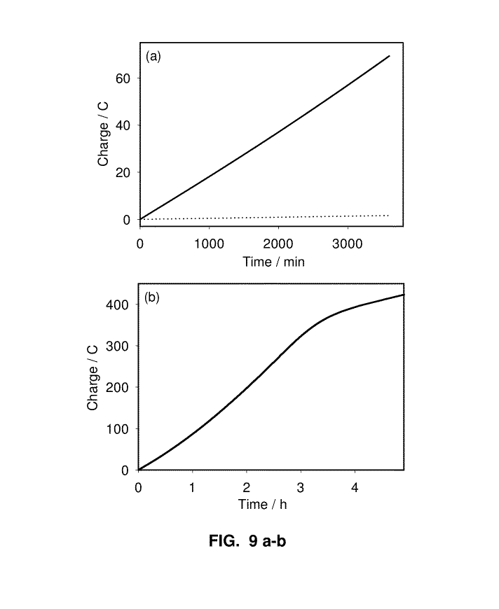

When the controlled potential experiment was conducted at −1.3 V (vs SHE), the Faradaic efficiency was determined to be 98±2%. On the basis of consumed charges over 1 h bulk electrolysis at −1.4 V (vs SHE) in 1.0 M phosphate buffer at pH 7 in the presence of 50 μM complex 2, the H₂ evolution activity of complex 2 was calculated to be 1400 L H₂ (mol cat)⁻¹ h⁻¹(cm² Hg)⁻¹ (FIG. 9a), or a turnover number (TON) of >300 mol H₂ (mol cat)⁻¹, suggesting the reduced form of complex 2 is a highly efficient electrocatalyst for proton reduction in neutral aqueous solution. FIG. 9b also suggests that the activity of complex 2 decreased after more than 3 h electrolysis.

Catalytic H₂ production at a potential lower than the Co^{II/I} couple of complex 2 suggested that Co^{I} form of complex 2 is responsible for proton reduction (see Scheme 2).

### EXAMPLE 5

### Photocatalytic H₂ Production

Photocatalytic H₂ production by complex 2 using ascorbic acid as electron donor and [Ru(bpy)₃]²⁺ as photosensitizer was performed. Photolysis experiments were carried out in 10 mL 1.0 M acetate buffer solution at pH 4.0 containing 0.1 M ascorbic acid and 0.5 mM [Ru(bpy)₃]²⁺. Each sample was prepared in a 130 mL rectangular flask containing 10 mL of buffer in the presence of [Ru(bpy)₃]Cl₂, ascorbic acid, and complex 2. The flask was sealed with a septum, degassed under vacuum, and flushed with Ar (with 5% CH₄) four times to remove any air present. Each sample was irradiated by an LED light (450 nm) at room temperature with constant stirring. The amounts of H₂ produced during photocatalysis were determined by gas chromatography using a HP 5890 series II Gas Chromatograph with a TCD detector (Molecular sieve 5 Å column) or measured volumetrically by a gas burette.

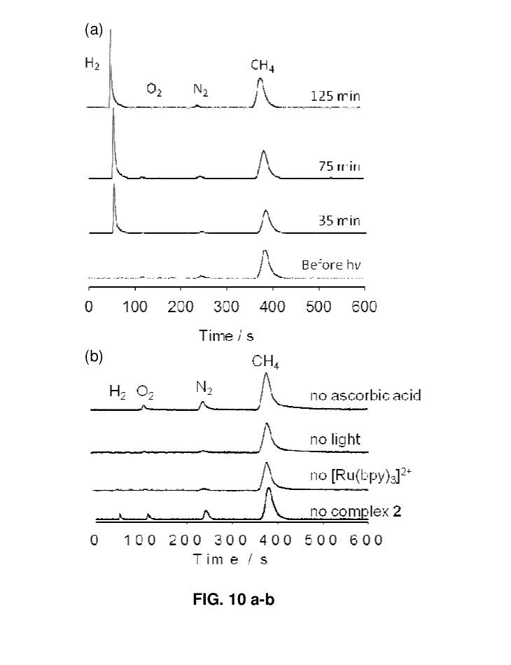

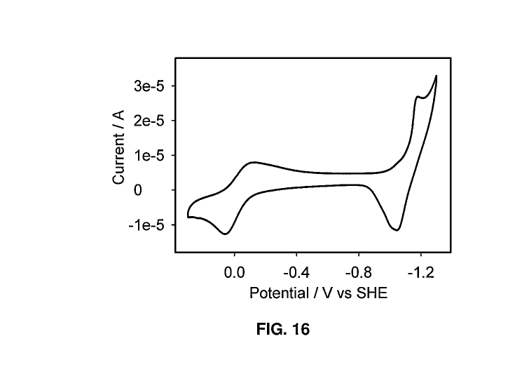

As shown in FIGS. 16 and 10a, formation of H₂ was observed upon photolysis (LED light at 450 nm) of the above pH 4 solution in the presence of 5.0 μM complex 2. The H₂ evolution process ceased in ˜3 h, with a TON of >1600 mol H₂ (mol cat)⁻¹. However, nearly 90% of the H₂ evolved within the first hour of irradiation, corresponding to a turnover frequency (TOF) of 1500 mol H₂ (mol cat)⁻¹h⁻¹ (FIG. 16).

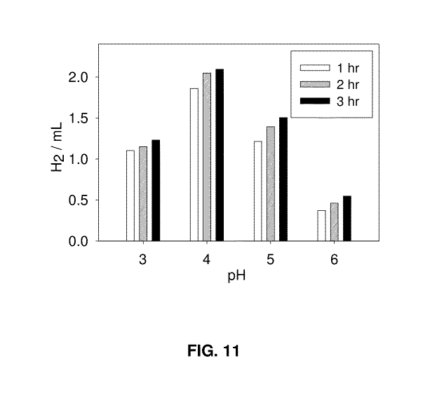

To determine the pH effects on H₂ evolution catalyzed by complex 2, light-induced H₂ evolution was performed in the pH range of 3-6 under the conditions described in FIG. 16. An optimum pH of 4.0 was observed for H₂ evolution (FIG. 11). The pH-dependent activity has been related to the pKa of ascorbic acid, since it is believed that ascorbic acid acts as both a proton and electron donor for H₂ production.

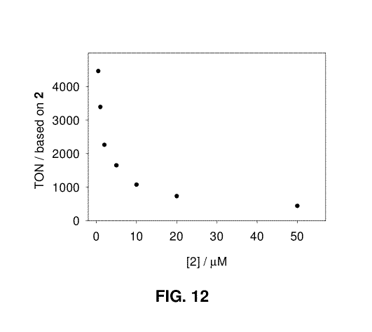

To explore the dependence of H₂ activity on the concentration of complex 2, photolysis experiments were conducted using different concentration of complex 2 (0.5-50 μM) at pH 4.0. As shown in FIG. 12, the concentration of complex 2 has a great influence on the light-induced H₂ evolution activity in terms of TON and TOF, which increased significantly at lower concentration of catalyst. At 50 μM complex 2, a TON of ˜450 mol H₂ (mol cat)⁻¹ and TOF of 410 mol H₂ (mol cat)⁻¹h⁻¹ were obtained. However, at 1.0 μM complex 2, the TON and TOF increased drastically to 4400 mol H₂ (mol cat)⁻¹ and 4000 mol H₂ (mol cat)⁻¹h⁻¹, respectively. The dependence of TON and TOF on catalyst concentration indicates that the formation of binuclear or polynuclear species might be involved in the inactivation of complex 2.

### EXAMPLE 6

### Control Photolysis Experiments

To identify factors responsible for the decomposition of photocatalytic H₂ evolution in the above system, one of the three components (ascorbic acid, [Ru(bpy)₃]²⁺, or complex 2) was added to a reaction flask after the cessation H₂ evolution to see if H₂ production could be resumed.

Addition of any one of the three components, in the same amount as that used in photocatalytic reaction, resulted in no significant amount of H₂ formation, suggesting the decomposition of all three species occurred during photocatalytic H₂ evolution. Both complex 2 and photosensitizer need to be added to resume H₂ production, with ˜37% more H₂ production (FIG. 14). The addition of both ascorbic acid and [Ru(bpy)₃]²⁺ also led to an increase of H₂ evolution by ˜10%.

However, no significant amount of H₂ was produced when both ascorbic acid and complex 2 were added, suggesting a complete decomposition of [Ru(bpy)₃]²⁺ under the reaction conditions. The coordination of acetate ion to complex 2 or the substitution of bpy ligand in [Ru(bpy)₃]²⁺ by acetate ion may contribute to the decomposition of photocatalytic system for H₂ evolution. Furthermore, the presence of trace amount of air in reaction flask may also lead to the decomposition of catalytic system. The amount of H₂ produced in the presence of air is only 40% of that produced when the H₂ evolution was conducted under Ar, suggesting O₂ does inhibit H₂ evolution.

Control experiments without ascorbic acid, [Ru(bpy)₃]²⁺, or complex 2 showed no or only residual amounts of H₂ production, suggesting all three components are required for H₂ evolution (FIG. 10b).

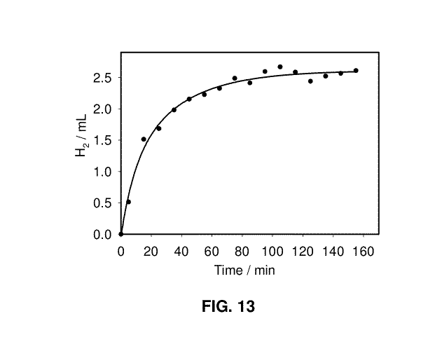

When photolysis experiment was conducted at higher concentration of ascorbic acid (0.5 M) and [Ru(bpy)₃]²⁺ (2.0 mM) with 5.0 μM complex 2, the TON increased further from 1600 to 2100 mol H₂ (mol cat)⁻¹, corresponding to a TOF of >1900 mol H₂ (mol cat)⁻1h⁻¹ during the first hour irradiation (FIG. 13). The above studies demonstrated that the light-induced H₂ production catalyzed by complex 2 also depends on the concentrations of sacrificial reagent and photosensitizer and that the reduced form of complex 2 acts as a highly efficient photocatalyst for H₂ evolution.

### EXAMPLE 7

### Structure Determination

The suitable crystals for X-ray crystallography of the Co^{III} form of complex 1 were grown from a solution of complex 1 in CH₃CN/CH₂Cl₂ (1:1) in air. The crystal was flash cooled to 100 K for X-ray analysis on a Bruker D8 diffractometer 3-circle diffractometer with fixed χ. The crystal was illuminated with the X-ray beam from a FR-591 rotating-anode X-ray generator equipped with a copper anode and Helios focusing mirrors. The resulting images were integrated with the Bruker SAINT software package using a narrow-frame algorithm.

The structure was solved and refined via the Bruker SHELXTL software package, using the space group P−1, with Z =2 for the formula unit, C_{25.38}H_{24.76}Cl_{3.76}CoN₆. Hydrogen atoms were located in difference electron density maps and refined freely as isotropic contributors. The final anisotropic full-matrix least-squares refinement converged at R1=4.78% for the observed data and wR2=12.36% for all data. The crystals also contain a small region of disordered solvent that could not be well resolved. The disposition of the electron density in that region strongly suggests two chlorine atoms of a methylene chloride molecule at approximately 40% occupancy, but the corresponding carbon atom could not be located. The disordered region was treated with the help of the SQUEEZE program, therefore no atoms are modeled there. SQUEEZE's estimate of 32 electrons per asymmetric unit in the disordered area is consistent with methylene chloride at 38% occupancy and the formulae and derived parameters reported herein reflect that interpretation.

The crystal structure has been deposited at the Cambridge Crystallographic Data Centre with the deposition number: CCDC 860449, the chemical and crystal data of which is presented in Table 3:

TABLE 3
Chemical and Crystal Data of [Co(DPA-Bpy)(Cl)]Cl₂•(CH₃CN)
(CCDC 860449)

| Formula | C_{25.38}H_{24.76}Cl_{3.76}CoN₆ |
|---|---|
| Mol. wt. | 606.05 |
| Crystal system | Triclinic |
| Space group | P-1 |
| a (Å) | 9.2901(2) |
| b (Å) | 11.1802(2) |
| c (Å) | 13.9726(3) |
| α/° | 70.0560(10) |
| β/° | 81.9510(10) |
| γ/° | 74.7420(10) |
| V (Å³) | 1314.12(5) |
| Z | 2 |
| Density (g/cm³) | 1.532 |
| Abs. coeff. (mm⁻¹) | 8.857 |
| Abs. correction | multi-scan |
| F(000) | 620 |
| Total no. of reflection | 15946 |
| [symbol] | |
| Reflections, I > 2σ(I) | 4474 |
| Max. 2θ/° | 71.540 |
| Ranges (h, k, l) | −11 ≦ h ≦ 10 |
| | −13 ≦ k ≦ 11 |
| | −17 ≦ l ≦ 17 |
| Complete to 2θ (%) | 95.0 |
| Data/restraints/parameters | 4874/0/412 |
| Goof (F2) | 1.050 |
| R indices [I > 2σ(I)] | 0.0478 |
| R indices (all data) | 0.0514 |
| wR₂ indices | 0.1236 |

[symbol]

indicates data missing or illegible when filed

### EXAMPLE 8

### The H₂ Evolution Activity of Complex 3

The H₂ evolution activity of complex 3 was investigated in a mixed solvent of EtOH/H₂O (1:1) under irradiation (LED light, 520 nm) containing 5 μM complex 3, 2 mM FL, and 10% TEA, with a TON of 2000 mol H₂ (mol cat)⁻¹ after 30 h photolysis, ˜25% more than that of [Ni(DPA-Bpy)(H₂O)](BF₄)₂ under the same conditions.

The examples as above presented are not intended to limit the scope of what the inventors regard as their invention.

Further, all the documents mentioned in this disclosure are incorporated herein by reference in their entirety.

### REFERENCES

[1] a) N. S. Lewis, D. G. Nocera, Proc. Natl. Acad. Sci. U.S.A. 2006, 103, 15729-15735; b) V. Balzani, A. Credi, M. Venturi, ChemSusChem 2008, 1, 26-58; c) J. Barber, Biochem. Soc. Trans. 2006, 34, 619-631; d) O. Kruse, J. Rupprecht, J. H. Mussgnug, G. C. Dismukes, B. Hankamer, Photochem. Photobiol. Sci. 2005, 4, 957-970.
[2]a) P. V. Bernhardt, L. A. Jones, Inorg. Chem. 1999, 38, 5086-5090; b) X. Hu, B. S. Brunschwig, J. C. Peters, J. Am. Chem. Soc. 2007, 129, 8988-8998; c) C. Baffert, V. Artero, M. Fontecave, Inorg. Chem. 2007, 46, 1817-1824; d) J. P. Bigi, T. E. Hanna, W. H. Harman, A. Chang, C. J. Chang, Chem. Commun. 2010, 46, 958-960; e) Y. Sun, J. P. Bigi, N. A. Piro, M. L. Tang, J. R. Long, C. J. Chang, J. Am. Chem. Soc. 2011, 133, 9212-9215; f) P.-A. Jacques, V. Artero, J. Pécaut, M. Fontecave, Proc. Natl. Acad. Sci. U.S.A. 2009, 106, 20627-20632; g) J. L. Dempsey, B. S. Brunschwig, J. R. Winkler, H. B. Gray, Acc. Chem. Res. 2009, 42, 1995-2004; h) W. R. McNamara, Z. Han, P. J. Alperin, W. W. Brennessel, P. L. Holland, R. Eisenberg, J. Am. Chem. Soc. 2011, 133, 15368-15371; i) V. Artero, M. Chavarot-Kerlidou, M. Fontecave, Angew. Chem., Int. Ed. 2011, 50, 7238-7266; j) R. M. Kellett, T. G. Spiro, Inorg. Chem. 1985, 24, 2373-2377; k) G. M. Jacobsen, J. Y. Yang, B. Twamley, A. D. Wilson, R. M. Bullock, M. Rakowski DuBois, D. L. DuBois, Energy Environ. Sci. 2008, 1, 167-174; 1) E. S. Wiedner, J. Y. Yang, W. G. Dougherty, W. S. Kassel, R. M. Bullock, M. R. DuBois, D. L. DuBois, Organometallics 2010, 29, 5390-5401; m) C. Creutz, N. Sutin, Coord. Chem. Rev. 1985, 64, 321-341; n) N. Sutin, C. Creutz, E. Fujita, Comments Inorg. Chem. 1997, 19, 67-92.
[3] a) J. P. Collin, A. Jouaiti, J. P. Sauvage, Inorg. Chem. 1988, 27, 1986-1990; b) M. Rakowski Dubois, D. L. Dubois, Acc. Chem. Res. 2009, 42, 1974-1982; c) A. Le Goff, V. Artero, B. Jousselme, P. D. Tran, N. Guillet, R. Métayé, A. Fihri, S. Palacin, M. Fontecave, Science 2009, 326, 1384-1387; d) U. J. Kilgore, J. A. S. Roberts, D. H. Pool, A. M. Appel, M. P. Stewart, M. R. DuBois, W. G. Dougherty, W. S. Kassel, R. M. Bullock, D. L. DuBois, J. Am. Chem. Soc. 2011, 133, 5861-5872; e) M. L. Helm, M. P. Stewart, R. M. Bullock, M. R. DuBois, D. L. DuBois, Science 2011, 333, 863-866.
[4] a) G. A. N. Felton, A. K. Vannucci, J. Chen, L. T. Lockett, N. Okumura, B. J. Petro, U. I. Zakai, D. H. Evans, R. S. Glass, D. L. Lichtenberger, J. Am. Chem. Soc. 2007, 129, 12521-12530; b) M. Y. Darensbourg, E. J. Lyon, X. Zhao, I. P. Georgakaki, Proc. Natl. Acad. Sci. U.S.A. 2003, 100, 3683-3688; c) C. Tard, X. Liu, S. K. Ibrahim, M. Bruschi, L. D. Gioia, S. C. Davies, X. Yang, L.-S. Wang, G. Sawers, C. J. Pickett, Nature 2005, 433, 610-613; d) L. Sun, B. Åkermark, S. Ott, Coord. Chem. Rev. 2005, 249, 1653-1663; e) S. Kaur-Ghumaan, L. Schwartz, R. Lomoth, M. Stein, S. Ott, Angew. Chem., Int. Ed. 2010, 49, 8033-8036; f) R. Mejia-Rodriguez, D. Chong, J. H. Reibenspies, M. P. Soriaga, M. Y. Darensbourg, J. Am. Chem. Soc. 2004, 126, 12004-12014; g) F. Gloaguen, J. D. Lawrence, T. B. Rauchfuss, J. Am. Chem. Soc. 2001, 123, 9476-9477; h) F. Wang, W.-G. Wang, X.-J. Wang, H.-Y. Wang, C.-H. Tung, L.-Z. Wu, Angew. Chem., Int. Ed. 2011, 50, 3193-3197; i) P. Poddutoori, D. T. Co, A. P. S. Samuel, C. H. Kim, M. T. Vagnini, M. R. Wasielewski, Energy Environ. Sci. 2011, 4, 2441-2450; j) W. M. Singh, D. Pegram, H. Duan, D. Kalita, P. Simone, G. L. Emmert, X. Zhao, Angew. Chem., Int. Ed. 2012, 51, 1653-1656.
[5] a) A. M. Appel, D. L. DuBois, M. R. DuBois, J. Am. Chem. Soc. 2005, /27, 12717-12726; b) H. I. Karunadasa, C. J. Chang, J. R. Long, Nature 2010, 464, 1329-1333.
[6] a) H. Ozawa, M. Haga, K. Sakai, J. Am. Chem. Soc. 2006, /28, 4926-4927; b) T. Lazarides,

T. McCormick, P. Du, G. Luo, B. Lindley, R. Eisenberg, J. Am. Chem. Soc. 2009, 131, 9192-9194; c) P. Zhang, M. Wang, J. Dong, X. Li, F. Wang, L. Wu, L. Sun, J. Phys. Chem. C 2010, 114, 15868-15874; d) A. Fihri, V. Artero, M. Razavet, C. Baffert, W. Leibl, M. Fontecave, Angew. Chem., Int. Ed. 2008, 47, 564-567; e) D. Streich, Y. Astuti, M. Orlandi, L. Schwartz, R. Lomoth, L. Hammarström, S. Ott, Chem.-Eur. J. 2010, 16, 60-63; f) J. L. Dempsey, J. R. Winkler, H. B. Gray, J. Am. Chem. Soc. 2009, 132, 1060-1065; g) T. M. McCormick, B. D. Calitree, A. Orchard, N. D. Kraut, F. V. Bright, M. R. Detty, R. Eisenberg, J. Am. Chem. Soc. 2010, 132, 15480-15483; h) B. Probst, A. Rodenberg, M. Guttentag, P. Hamm, R. Alberto, Inorg. Chem. 2010, 49, 6453-6460; i) F. Gaertner, B. Sundararaju, A.-E. Surkus, A. Boddien, B. Loges, H. Junge, P. H. Dixneuf, M. Beller, Angew. Chem., Int. Ed. 2009, 48, 9962-9965; j) C. V. Krishnan, N. Sutin, J. Am. Chem. Soc. 1981, 103, 2141-2142.
[7] B. D. Stubbert, J. C. Peters, H. B. Gray, J. Am. Chem. Soc. 2011, 133, 18070-18073.
[8] B. Radaram, J. A. Ivie, R. M. Grudzien, J. H. Reibenspies, C. E. Webster, X. Zhao, Inorg. Chem. 2011, 50, 10564-10571.
[9] A. Bencini, C. Benelli, D. Gatteschi, C. Zanchini, Inorg. Chem. 1980, 19, 3027-3030.
[10] a) B. Probst, C. Kolano, P. Hamm, R. Alberto, Inorg. Chem. 2009, 48, 1836-1843; b) K. L. Mulfort, D. M. Tiede, J. Phys. Chem. B 2010, 114, 14572-14581.
[11] a) B. H. Solis, S. Hammes-Schiffer, Inorg. Chem. 2011, 50, 11252-11262; b) B. H. Solis, S. Hammes-Schiffer, J. Am. Chem. Soc. 2011, 133, 19036-19039.
[12] U. Koelle, S. Paul, Inorg. Chem. 1986, 25, 2689-2694.
[13] a) C. Creutz, N. Sutin, B. S. Brunschwig, J. Am. Chem. Soc. 1979, 101, 1297-1298; b) J. L. Dempsey, J. R. Winkler, H. B. Gray, J. Am. Chem. Soc. 2010, 132, 16774-16776.

We claim:

1. A metal complex of formula (I):
[M(G)Y]ₘ(X)ₙ(L)ₐ (I)
wherein
M is a transition metal;
G is N,N-bis(2-pyridinylmethyl)-2,2′-bipyridine-6-methanamine (“DPA-Bpy”) or a derivative thereof;
Y, on each occurrence, independently is a halogen group or a water moiety;
X, on each occurrence, independently is an anion;
m is the number of cations per metal complex;
n is the number of anions per metal complex;
L is absent or a neutral molecule; and
a is the number of neutral molecules per metal complex;
provided that when G is N,N-bis(2-pyridinylmethyl)-2,2′-bipyridine-6-methanamine (“DPA-Bpy”), M is not Ru.

2. The metal complex of claim 1, wherein said metal is cobalt.

3. The metal complex of claim 2, wherein Y is chloride.

4. The cobalt complex of claim 3, wherein a is 0; and X is Cl⁻.

5. The cobalt complex of claim 4, wherein said cobalt complex is Co(DPA-Bpy)Cl₂.

6. The cobalt complex of claim 3, wherein L is (C₁₋₃)alkyl-CN, and a is 1.

7. The cobalt complex of claim 6, wherein said cobalt complex is [Co(DPA-Bpy)(Cl)]Cl₂.(CH₃CN).

8. The cobalt complex of claim 1, wherein said cobalt complex is of formula (II) 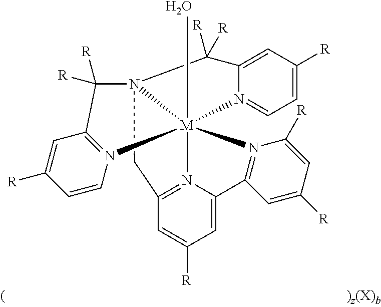
wherein
M is Co, Ru, Ni, or Fe;
R, on each occurrence, independently is H, (C₁₋₃)alkyl, cyano, aryl, benzyl, amino, nitrile, carboxylate, hydroxyl, or ester;
X, on each occurrence, independently is an anion
z is the number of cations per metal complex, and
b is the number of anions per metal complex;
or a salt, solvate or hydrate thereof.

9. The metal complex of claim 8, wherein M is Co or Ni.

10. The metal complex of claim 9, wherein R are all H, and z is 1.

11. The metal complex of claim 9, wherein X is PF₆⁻ or BF₄⁻.

12. The metal complex of claim 10, wherein said metal complex is [Co(DPA-Bpy)(OH₂)](PF₆)₃ or [Ni(DPA-ABpy)(OH₂)](BF₄), or a salt, solvate or hydrate thereof.

13. A metal complex of formula (III):
[M(G)Y]ₘ(X)ₙ(L)ₐ (III)
or a salt, solvate or hydrate thereof;
wherein
M is a transition metal;
G is N,N-bis(2-pyridinylmethyl)-2,2′-bipyridine-6-methanamine (“DPA-Bpy”), 6′-((bis(pyridin-2-ylmethyl)amino)methyl)-N,N-dimethyl-2,2′-bipyridin-6-amine (“DPA-ABpy”), or a derivative thereof;
Y, on each occurrence, independently is absent, a halogen group or a water moiety;
X, on each occurrence, independently is an anion;
m is the number of cations per metal complex;
n is the number of anions per metal complex;
L is absent or a neutral molecule; and
a is the number of neutral molecules per metal complex;
provided that when G is N,N-bis(2-pyridinylmethyl)-2,2′-bipyridine-6-methanamine (“DPA-Bpy”), M is not Ru.

14. The metal complex of claim 13, wherein M is Co, Ru, Ni, or Fe.

15. The metal complex of claim 14, wherein G is DPA-Bpy or DPA-ABpy.

16. The metal complex of claim 14, wherein Y is absent or a water moiety.

17. The metal complex of claim 14, wherein X is PF₆⁻ or BF₄⁻.

18. The metal complex of claim 14, wherein said metal complex is [Ni(DPA-ABpy)(OH₂)](BF₄)₂ or [Co(DPA-ABpy)](PF₆)₂, or a salt, solvate or hydrate thereof.

19. A catalyst comprising a metal complex of formula (I) or (III).

20. A process for producing hydrogen from an aqueous solution comprising a step of adding a catalyst of claim 19 to said aqueous solution.

21. The process of claim 20, further comprising a step of carrying out electrolysis on the aqueous solution containing the catalyst.

22. The process of claim 20, further comprising a step of carrying out photolysis on the aqueous solution containing the catalyst.

23. The process of claim 22, wherein said aqueous solution comprises ascorbic acid.

24. The process of claim 23, wherein the aqueous solution containing the catalyst has a pH value at about 3 to 6.

25. The process of claim 20, wherein said catalyst comprises [Co(DPA-Bpy)(OH₂)](PF₆)₃, [Ni(DPA-ABpy)(OH₂)](BF₄), or [Co(DPA-ABpy)](PF₆)₂.
